(19) United States
(12) Patent Application Publication
(10) Pub. No.: US 2018/0154709 A1
(43) Pub. Date: Jun. 7, 2018

(54) WHEEL IMBALANCE DETECTION SYSTEM AND METHOD

(71) Applicant: The Goodyear Tire & Rubber Company, Akron, OH (US)

(72) Inventors: Kanwar Bharat SINGH, Lorenztweiler (LU); Eric Michael HERZFELD, New York, NY (US)

(21) Appl. No.: 15/796,932

(22) Filed: Oct. 30, 2017

Related U.S. Application Data
(60) Provisional application No. 62/430,025, filed on Dec. 5, 2016.

(51) Int. Cl. B60C 23/04

(52) U.S. Cl. CPC B60C 23/0488

(57) ABSTRACT

The invention relates generally to tire monitoring systems for collecting measured tire parameter data during vehicle operation and, more particularly, to a system and method for estimating wheel imbalance based upon measurements.

### FIELD OF THE INVENTION

The invention relates generally to tire monitoring systems for collecting measured tire parameter data during vehicle operation and, more particularly, to a system and method for detecting a wheel imbalance during vehicle operation.

### BACKGROUND OF THE INVENTION

Vehicle-mounted tires may be monitored by tire pressure monitoring systems (TPMS) which measure tire parameters such as pressure and temperature during vehicle operation. Data from TPMS tire-equipped systems is used to ascertain the status of a tire based on measured tire parameters and alert the driver of conditions, such as low tire pressure or leakage, which may require remedial maintenance. Sensors within each tire are typically installed in a green or uncured tire and then subject to cure at high temperatures. The high temperature and pressure can damage the sensor. Furthermore, additional cost is typically associated with mounting the sensor in the tire. It is generally desired to have a tire sensor that is durable enough to sustain 60 million cycles. Further, the location of the sensor makes it extremely difficult to replace if the sensor stops functioning.

Other factors such as tire wear state are important considerations for vehicle operation and safety. It is accordingly further desirable to measure tire wear state and communicate wear state to vehicle systems such as braking and stability control systems in conjunction with the measured tire parameters of pressure and temperature.

### SUMMARY OF THE INVENTION

According to one aspect of the invention, a tire or wheel imbalance detection system includes a sensor for measuring vertical acceleration of the tire. The sensor is preferably mounted on the wheel or rim, but may also be mounted elsewhere. The system senses the vertical acceleration signal, and continuously monitors the vertical acceleration signal in a specified frequency domain. When the amplitude of the signal exceeds a threshold amount, a notification alert is sent to a user.

### Definitions

“ANN” or “Artificial Neural Network” is an adaptive tool for non-linear statistical data modeling that changes its structure based on external or internal information that flows through a network during a learning phase. ANN neural networks are non-linear statistical data modeling tools used to model complex relationships between inputs and outputs or to find patterns in data.

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact created by the tire tread with a flat surface as the tire rotates or rolls.

“Inboard side” means the side of the tire nearest the vehicle when the tire is mounted on a wheel and the wheel is mounted on the vehicle.

“Kalman Filter” is a set of mathematical equations that implement a predictor-corrector type estimator that is optimal in the sense that it minimizes the estimated error covariance when some presumed conditions are met.

“Lateral” means an axial direction.

“Lateral edges” means a line tangent to the axially outermost tread contact patch or footprint as measured under normal load and tire inflation, the lines being parallel to the equatorial centerplane.

“Luenberger Observer” is a state observer or estimation model. A “state observer” is a system that provide an estimate of the internal state of a given real system, from measurements of the input and output of the real system. It is typically computer-implemented, and provides the basis of many practical applications.

“MSE” is an abbreviation for Mean square error, the error between and a measured signal and an estimated signal which the Kalman Filter minimizes.

“Net contact area” means the total area of ground contacting tread elements between the lateral edges around the entire circumference of the tread divided by the gross area of the entire tread between the lateral edges.

“Piezoelectric Film Sensor” a device in the form of a film body that uses the piezoelectric effect actuated by a bending of the film body to measure pressure, acceleration, strain or force by converting them to an electrical charge.

“PSD” is Power Spectral Density (a technical name synonymous with FFT (Fast Fourier Transform).

“Radial” and “radially” means directions radially toward or away from the axis of rotation of the tire.

### BRIEF DESCRIPTION OF THE DRAWINGS

The invention will be described by way of example and with reference to the accompanying drawings in which:

FIG. 1 is a flow chart of a wheel imbalance system process.

FIG. 2a is a front view of a wheel and sensor assembly;

FIG. 2b is a close up view of the sensor mounted on the wheel;

FIG. 3 is a schematic of a sensor system;

FIG. 4 is an exemplary acceleration signal;

FIG. 5 is a frequency graph showing an amplitude vs. frequency of the vertical acceleration signal, and particularly illustrating wheel hop and tire vertical mode.

FIG. 6 is a frequency graph showing an amplitude vs. frequency of the vertical acceleration signal that has been filtered to eliminate all but the wheel hop mode.

FIG. 7 is a schematic of a cross-section of a wheel which illustrates a rotational imbalance.

FIG. 8 compares a processed acceleration signal for a balanced and unbalanced wheel.

FIG. 9 illustrates a display of results on a user's cellphone.

FIG. 10 is a first embodiment of a wheel imbalance detector which outputs the imbalanced state of a tire based upon input data to the detector apparatus.

FIG. 11A is an amplitude vs frequency graph of the vertical acceleration signal at 60 mph for different known imbalance conditions.

FIG. 11B is an amplitude vs frequency graph of the acceleration signal showing the effect of vehicle speed for an exemplary rear tire of a vehicle at 25 mph and at 50 mph.

FIG. 11C is an amplitude vs frequency graph of the acceleration signal showing the effect of vehicle speed for an exemplary front tire of a vehicle at 25 mph and at 50 mph.

FIG. 12 is an amplitude vs frequency graph of the acceleration signal showing the effect of inflation pressure at 24 psi and at 32 psi.

FIG. 13 is an amplitude vs frequency graph of the acceleration signal showing the effect of road surface roughness, with the figure on the left representing a vehicle tire driven on regular asphalt, and the figure on the right representing a vehicle tire driven on rough asphalt.

FIG. 14 illustrates a Road Roughness Indicator that classifies the tire frequency Amplitude into three categories of Very Rough, Rough and Smooth based upon vehicle speed.

FIG. 15 is a signal kurtosis vs frequency for smooth asphalt and rough asphalt.

FIG. 16 illustrates the methodology for generating the wheel hop threshold values based upon different inputs of inflation pressure, road roughness and vehicle speed.

### DETAILED DESCRIPTION OF THE INVENTION

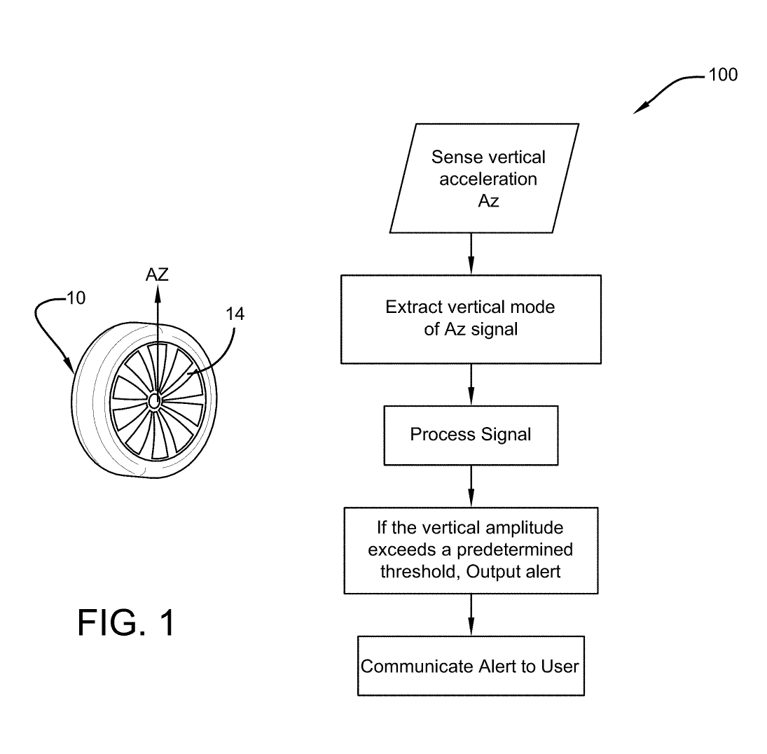

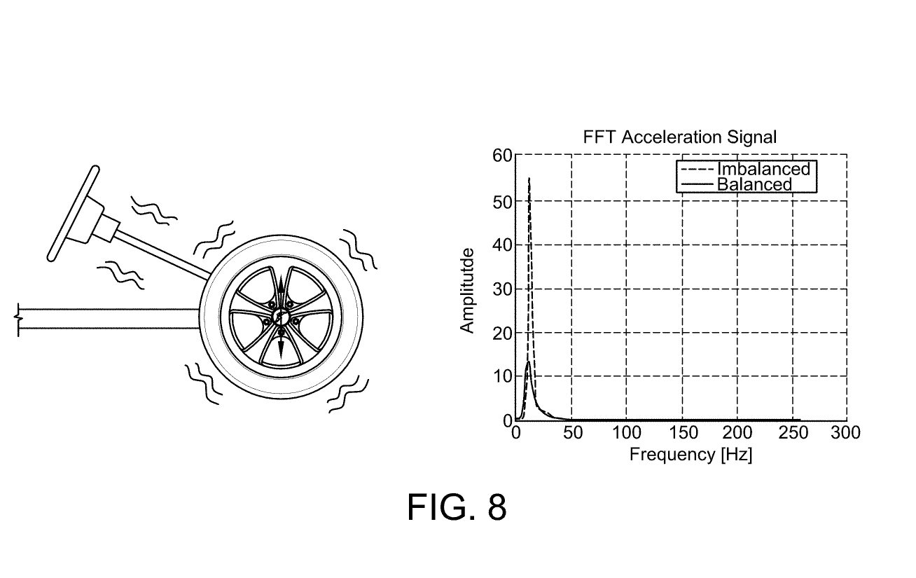

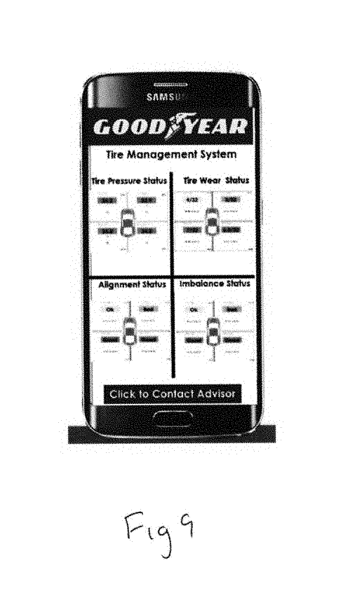

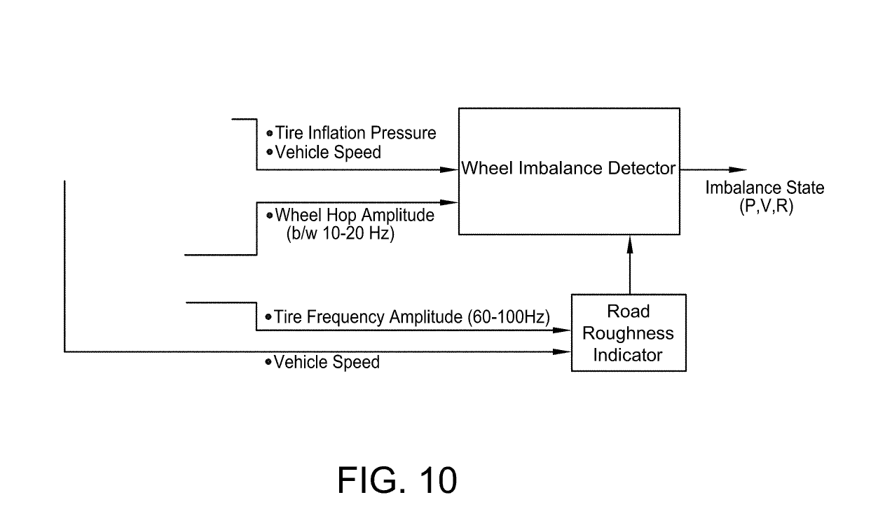

Referring to FIG. 1, a wheel imbalance detection system 100 is illustrated. The wheel imbalance detection system 100 is based upon the spectral analysis of the tire vibration signal. Such a system is useful in advising a vehicle owner on whether their tire is in a dynamically balanced state or whether the wheel needs serviced. As shown in FIG. 7, a wheel that is imbalanced during rotation results in an outward force that is directed in an opposite radial direction from the wheel center. During operation of the vehicle as shown in FIG. 8, a driver will normally feel vibrations transmitted to the steering wheel, but will not know for sure the source of the vibration.

As shown in FIG. 1, a representative wheel 10 is shown that is typically mounted upon a vehicle. The wheel 10 includes a tire 12 that is mounted upon a rim 14. The tire includes is typically mounted to a vehicle and includes a ground-engaging tread region 14 that wears over time.

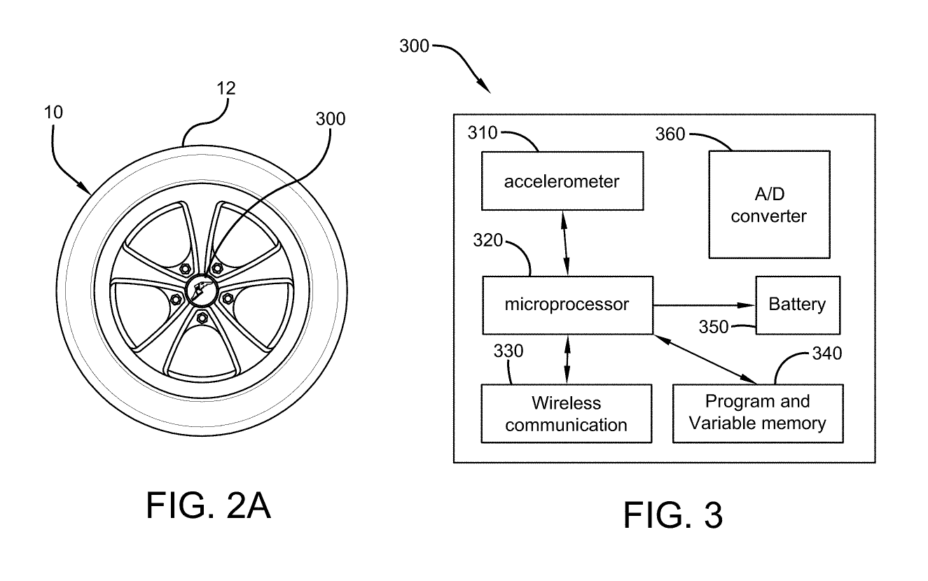

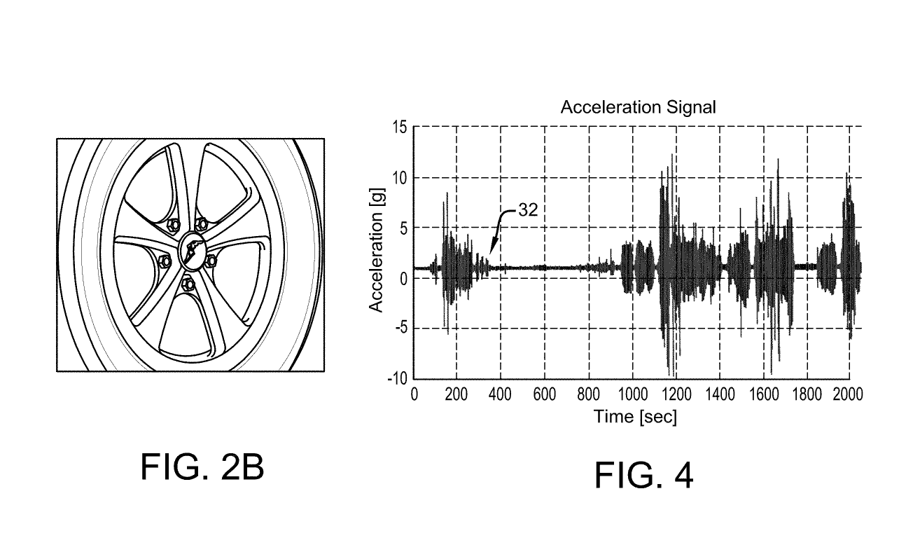

As shown in FIG. 2a, the wheel imbalance detection system 100 includes a sensor module 300 that is preferably mounted on the wheel 10. The sensor module 300 may also be mounted on a lug nut, valve stem, on the tire and inside the tire cavity or outside the tire cavity, on the rim, axle, hub, unsprung mass of the vehicle or vehicle suspension strut. The sensor module 300 preferably includes an accelerometer 310. The accelerometer 310 is preferably oriented to sense the radial or vertical acceleration Ax. As shown in FIG. 2a, the sensor module 300 is located on the wheel in an accessible position. As shown in FIG. 3, the sensor module 300 includes a microprocessor 320, wireless communication means 330 such as blue tooth, or other wireless communication means, data storage means 340, battery or power means 350 and an analog digital convertor 360. One sensor module 300 suitable for use with the invention is a Texas Instruments CC 2650 wireless MCU, sold by Texas Instruments.

FIG. 1 describes the steps of the wheel imbalance detection system. The first step of the system is to sense the vertical acceleration signal Az measured by the sensor module 300. The system input may also optionally include the longitudinal acceleration or radial acceleration signal, as described in more detail, below.

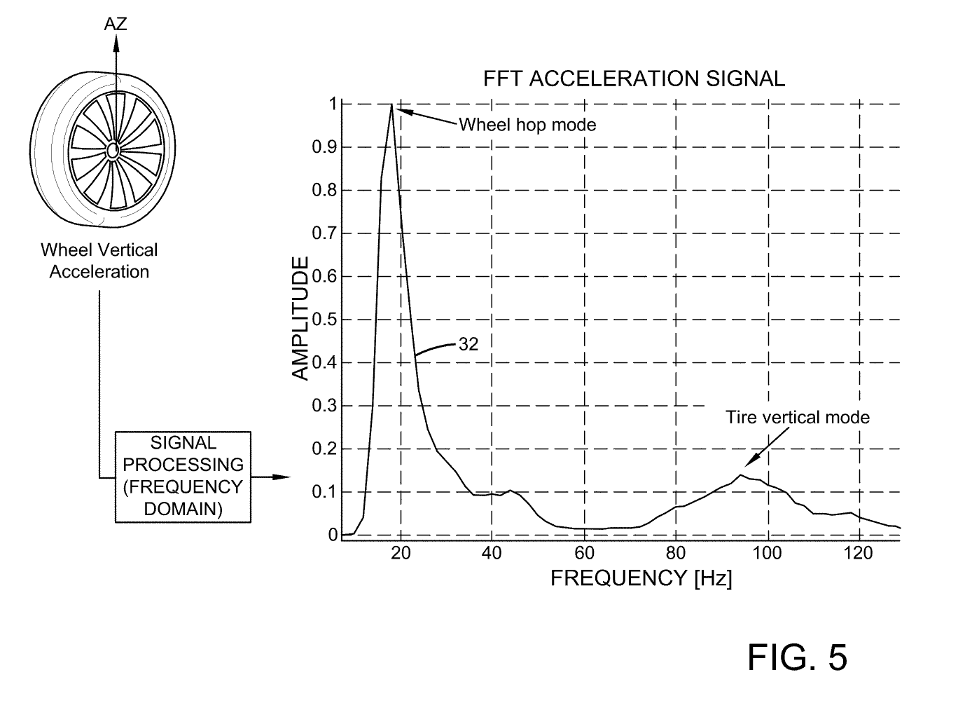

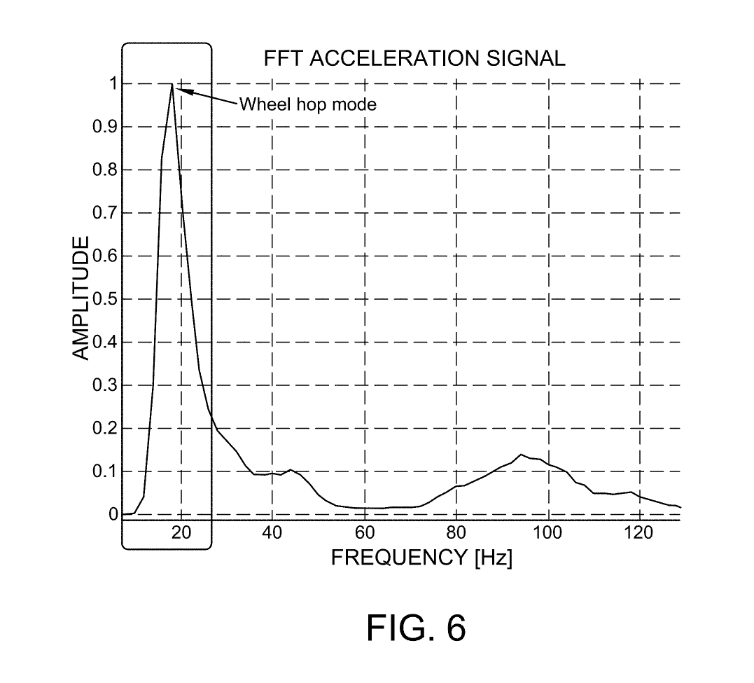

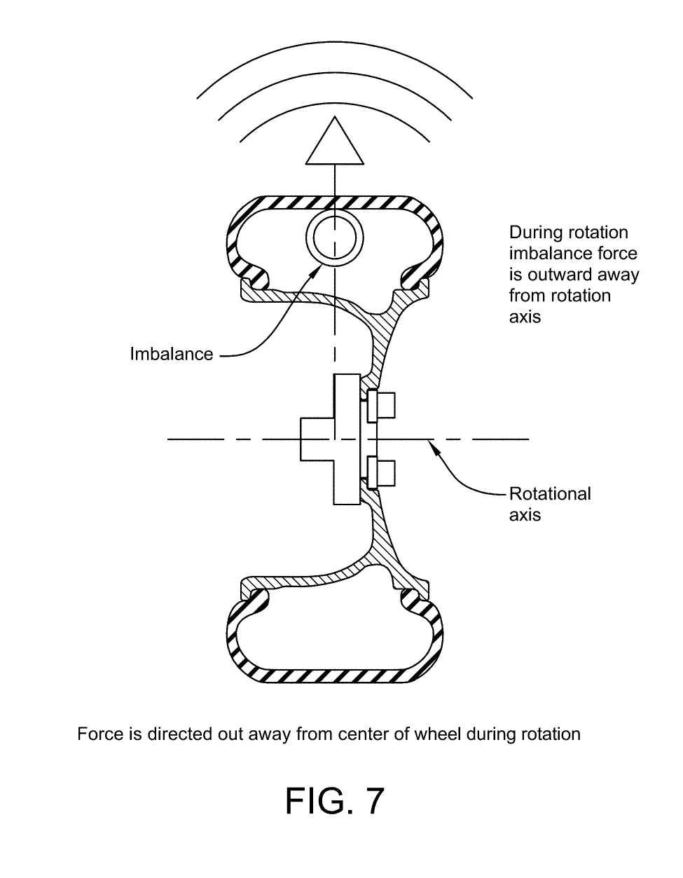

FIG. 4 illustrates an exemplary raw vertical acceleration signal Az 32 shown in the time domain. The Az signal 32 is then digitized by the A/D convertor 360 and then processed in the frequency domain by the microprocessor 320 of the sensor module. As shown in FIG. 5, the signal illustrates the signal peak at 18 Hz known as wheel hop. Wheel hop is typically representative around 12-15 Hz and is the vibration of the tire belt and rim. The wheel hop vertical mode depends mainly on suspension spring properties supporting the test wheel and tire and the overall tire stiffness. The Az signal 32 also shows a second signal peek at 90 Hz known as tire vertical mode. The tire vertical mode is typically in the frequency range of 90-100 HZ, and is representative of the tire belt vertical vibration. The Az signal is processed by the microprocessor of the sensor module 30 using a bandpass filter in the 0-120 hz range to isolate the wheel hop mode. The tire vertical mode was determined by means of an FFT (Fast Fourier Transform) analysis. The FFT analysis, conventionally used as a signal processing tool, yields tire vibration modes including the vertical mode represented in the subject graphs. As used herein, FFT is an algorithmic tool which operates by decomposing an N point time domain signal into N time domain signals each composed of a single point. The second step is to calculate the N frequency spectra corresponding to these N time domain signals. Lastly, the N spectra are synthesized into a single frequency spectrum. FIG. 6 illustrates the Az signal which has been processed as described.

Next, after the Az signal has been processed, it is compared with a predetermined threshold value to determine if the Az signal exceeds the threshold value. If the vertical acceleration signal exceeds an alarm threshold value, it is communicated to a user or vehicle by a wireless communication means, such as Blue Tooth.

More preferably, the above sensor module 300 senses the Tire ID, and uses the Tire ID information to retrieve the threshold value from memory. Preferably, the threshold value is determined experimentally for a given type of tire.

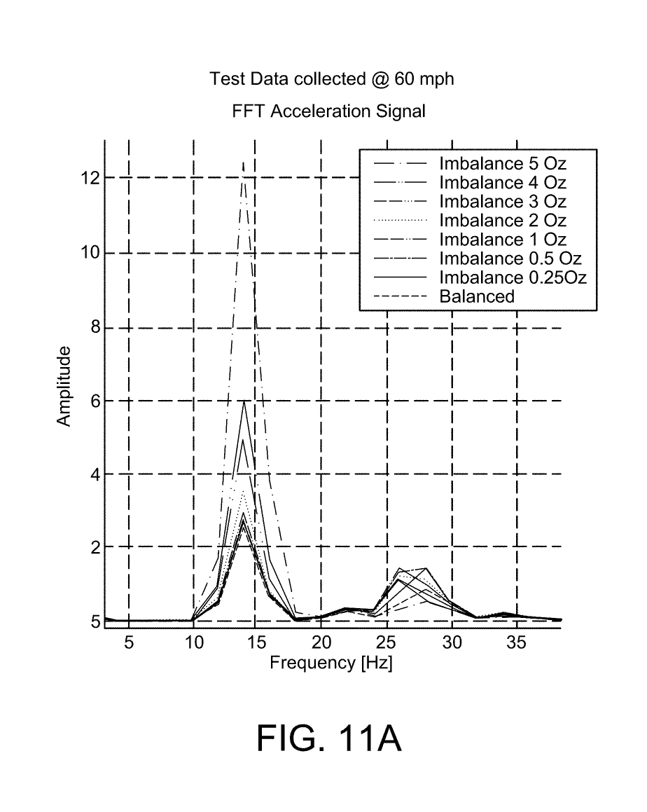

A second embodiment of the invention is shown in FIG. 10. A wheel imbalance detection apparatus is shown which outputs the imbalanced state of a tire based upon input data to the apparatus. The input data includes a tire acceleration signal from a sensor mounted on the wheel or on the tire. For greater accuracy, the input data may also include one or more of the following: tire pressure, vehicle speed and road roughness. The wheel imbalance detection system uses known calibration data to train the system algorithm which includes vehicle speed, tire inflation pressure for a vehicle having properly inflated and balanced tires and road roughness. The vehicle speed is also known from either measuring via a sensor, or input from the vehicle can bus system or manual input. A sensor is preferably mounted on the hub of each wheel for measuring the vertical acceleration signal in real time.

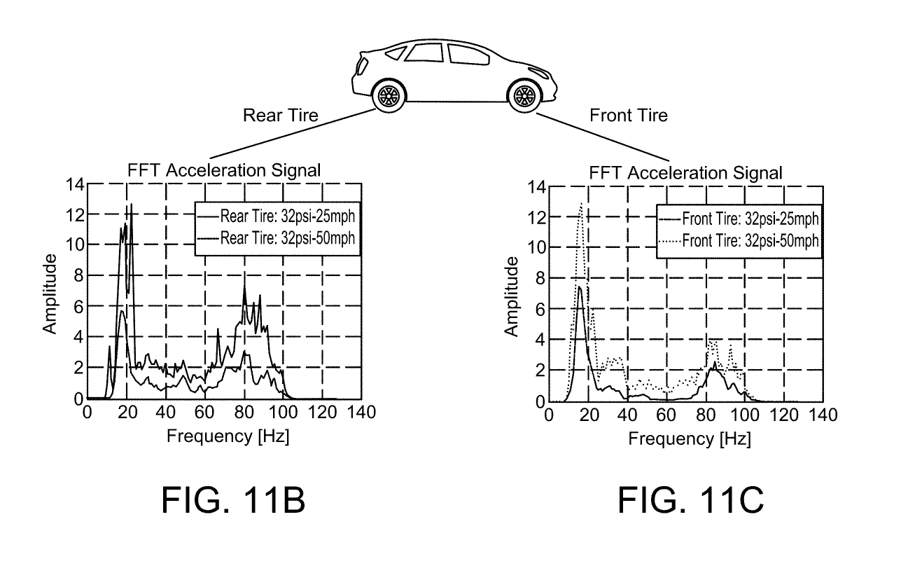

FIG. 11A illustrates vertical acceleration signal data for a tire travelling at 60 mph, with different levels of imbalance. The peak of the curve or wheel hop value in the 10 to 20 hz range appears to scale linearly with the level of imbalance. A wheel hop value is extracted from the peak of the wheel vertical acceleration signal. As further shown in FIGS. 11B and 11C, the magnitude of the wheel hop value is a function of vehicle speed and appears to scale linearly with vehicle speed. A first data set is created having a range of wheel hop amplitudes that is measured over a range of speeds at a known tire inflation pressure and vehicle speed.

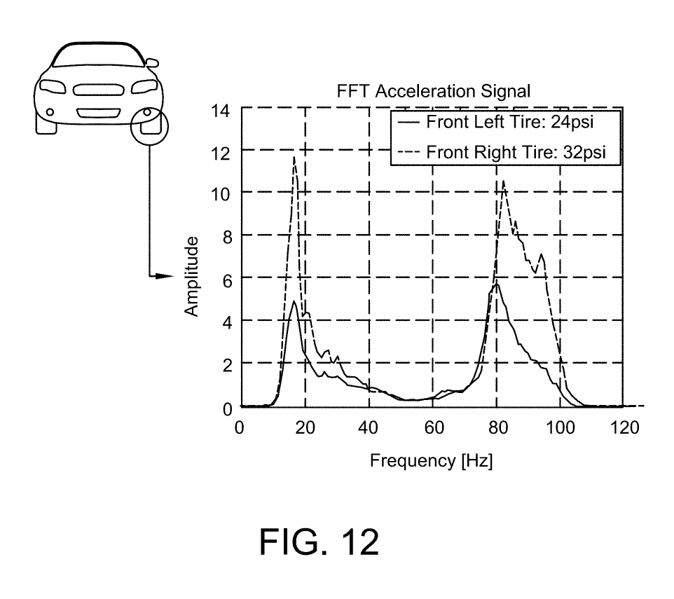

As shown in FIG. 12, it has been experimentally determined that wheel hop amplitude is a function of inflation pressure, and appears to scale linearly with inflation pressure. Inflation pressure can be input via a sensor in fluid communication with the tire pressure or manually input by a user. The wheel hop amplitude is measured over a range of known tire inflation pressures.

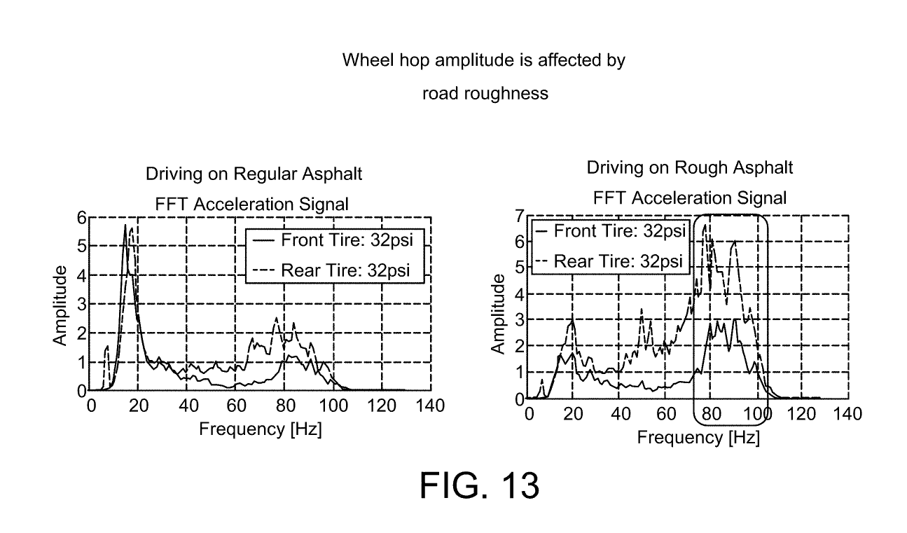

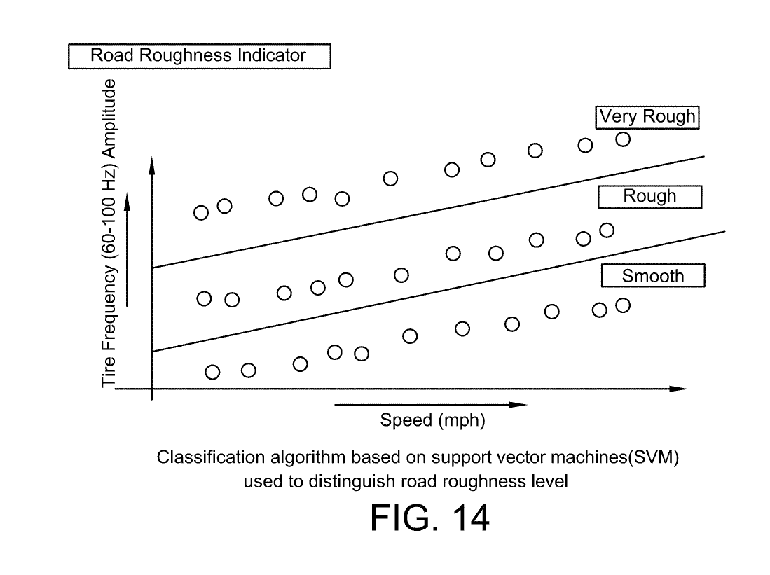

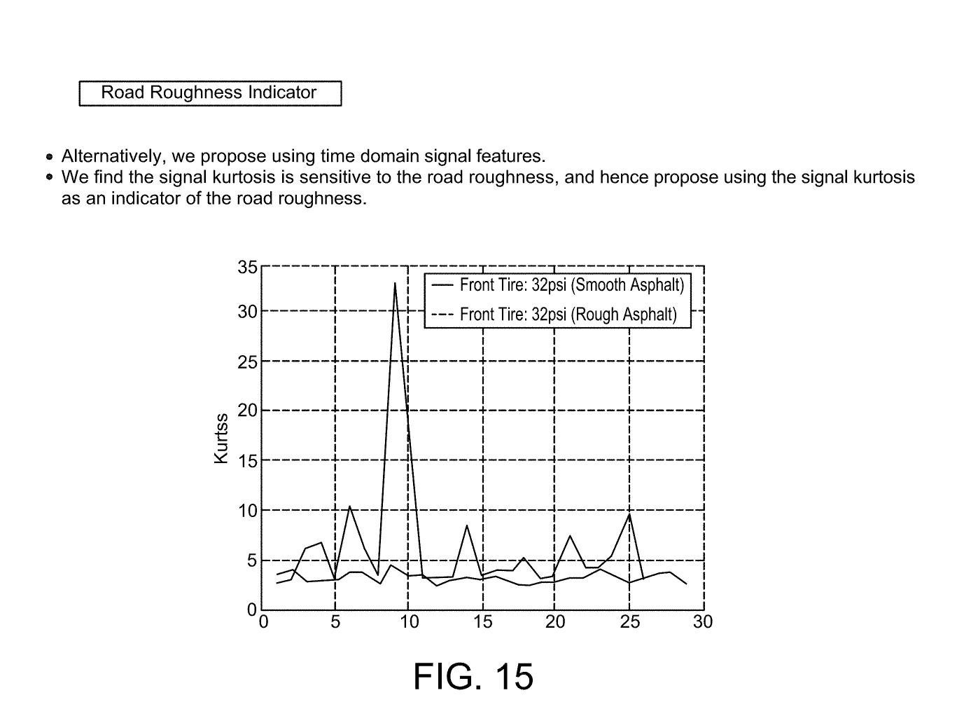

As shown in FIG. 13, the vertical acceleration signal is also affected by road roughness. The peak value of the vertical acceleration signal in the 60-100 Hz range is then determined as a function of road roughness for a given inflation pressure and vehicle speed. As shown in FIG. 14, a classification algorithm based upon support vector machines may be used to classify the road roughness levels into at least two zones, preferably at least three zones: smooth, rough, very rough.

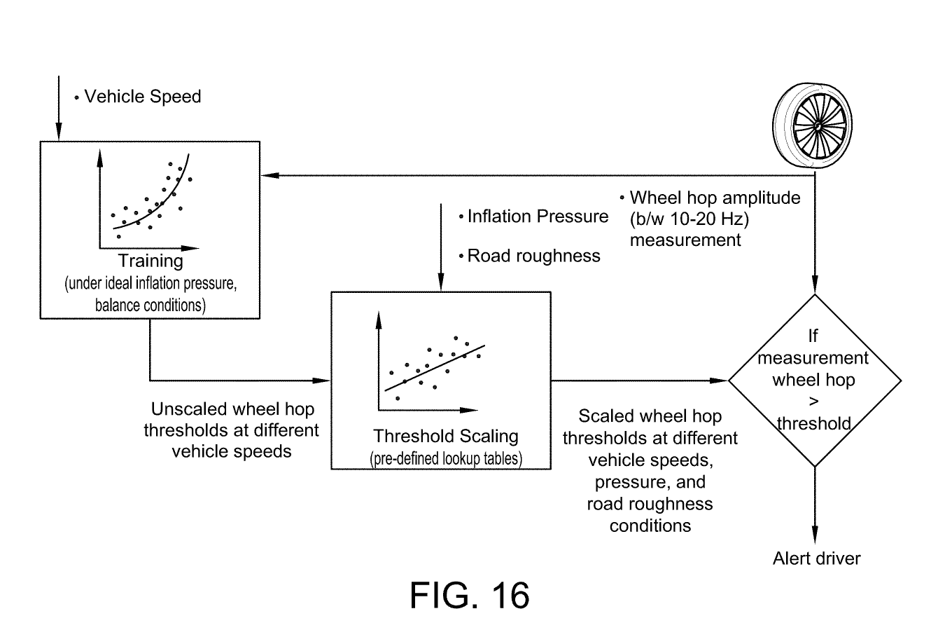

As shown in FIG. 16, data sets are generated for wheel hop values as a function of vehicle speed. These data sets are used for training the wheel balance detector over a range of vehicle speeds in order to determine a predetermined threshold value. The wheel balance detector uses an algorithm that utilizes the driving data to learn the predetermined wheel hop thresholds at different vehicle speeds. Linear scaling factors are then used to determine the predetermined wheel hop thresholds at different inflation pressures and road roughness conditions.

Once the predetermined wheel hop thresholds are determined based upon experimental data, the wheel imbalance detector apparatus uses the predetermined thresholds in conjunction with real time inputs which preferably include vehicle speed, tire inflation pressure and tire acceleration data. The wheel imbalance detector apparatus thus preferably uses the real time vehicle speed, the tire inflation pressure and acceleration data to continuously calculate the wheel hop value and then compare with the predetermined threshold. The predetermined threshold is a function of speed, inflation pressure and road roughness.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for detecting the imbalanced state of a wheel comprising the steps of:
utilizing a tire acceleration signal and generating tire vertical mode frequency data;
determining a wheel hop value from the peak of the curve of the tire vertical mode frequency data; and
determining if the wheel hop value is greater than a predetermined threshold value, and then sending an alert if an imbalance is detected.

2. The method of claim 1 further comprising the steps of determining a tire frequency amplitude from the tire vertical mode acceleration signal.

3. The method of claim 1 wherein a road roughness indicator is determined from a peak of the curve of the tire vertical mode frequency data in the 60-100 HZ frequency range.

4. The method of claim 1 wherein the wheel hop value is determined from the peak of the tire vertical mode frequency data in the 10-20 HZ frequency range.

5. The method of claim 1 wherein a vehicle speed is measured, and the predetermined threshold value is a function of vehicle speed.

6. The method of claim 1 wherein a tire inflation pressure is measured, and the predetermined threshold value is a function of inflation pressure.

7. The method of claim 3 wherein the predetermined threshold value is adjusted based upon the road roughness indicator.

8. A method for detecting the imbalanced state of a wheel comprising the steps of:
measuring a tire acceleration signal and extracting a vertical mode frequency data, measuring a tire inflation pressure and a vehicle speed;
determining a wheel hop value from the peak amplitude value of the vertical mode frequency data;
and then determining if the wheel hop is greater than a predetermined threshold value, wherein the predetermined threshold value is a function of inflation pressure and vehicle speed, and then sending an alert if an imbalance is detected.

9. The method of claim 8 wherein the predetermined threshold value is a function of a road roughness indicator, wherein the road roughness indicator is determined from the peak of the tire vertical mode acceleration signal in the 60-100 HZ frequency range.

10. A wheel imbalance detection apparatus for determining if a wheel is out of balance comprising:
tire vertical mode measuring means for measuring tire vertical mode frequency and generating tire vertical mode frequency data;
tire identification means for generating a tire-specific threshold value using tire-specific identification data; and
comparator for comparing the vertical mode frequency data with a threshold value.

11. The tire state estimation system of claim 10, wherein the measurement of the tire vertical mode frequency is from a wheel-mounted accelerometer.

12. The tire state estimation system of claim 10, wherein the measurement of the tire vertical mode frequency is from a tire-mounted accelerometer.
